(19) United States
(12) Patent Application Publication
(10) Pub. No.: US 2010/0253823 A1
(43) Pub. Date: Oct. 7, 2010

(54) IMAGE SENSOR AND IMAGE SENSOR MODULE

(75) Inventor: Tomotake HASUO, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/719,237

(22) Filed: Mar. 8, 2010

(30) Foreign Application Priority Data
Apr. 1, 2009 (JP) 2009-089359

(51) Int. Cl. H04N 5/335

(52) U.S. Cl. 348/294; 348/E05.091

(57) ABSTRACT

An image sensor includes a pulse input and output circuit that identifies a line synchronization pulse and an output start timing pulse sequentially input from an outside of a sensor chip, inputs the identified line synchronization pulse to an inside of the sensor chip and outputs the line synchronization pulse to an outside of the sensor chip, inputs the identified output start timing pulse to the inside of the sensor chip, and outputs an output start timing pulse, which is output from the input of the sensor chip after elapse of a fixed time from the input, to the outside of the sensor chip following the line synchronization pulse output to the outside.

### CROSS-REFERENCE TO RELATED APPLICATIONS

This application is based upon and claims the benefit of priority from the prior Japanese Patent Application No. 2009-089359, filed on Apr. 1, 2009; the entire contents of which are incorporated herein by reference.

### BACKGROUND OF THE INVENTION

1. Field of the Invention

The present invention relates to an image sensor and an image sensor module, and, more particularly to an image sensor and an image sensor module suitable for a contact type.

2. Description of the Related Art

In a contact image sensor module, a line synchronization pulse (an ST pulse) for instructing synchronization timing and an output start timing pulse (a TOUT pulse) for instructing output start timing are supplied to each of a plurality of contact image sensors (sensor chips) for one line mounted thereon as driving pulses for controlling operation timing. A driving pulse timing generator that generates the driving pulses is provided on the outside of the module (in a host apparatus) in some case and provided on the inside of the module in other case.

In the contact image sensor module, there is a strong demand for a reduction in size because of a characteristic of the product. Therefore, in the supply of the TOUT pulse to the respective sensor chips, the driving pulse timing generator generates only one TOUT pulse in the same manner as the generation of one ST pulse from the viewpoint of a reduction in wiring. In this case, the driving pulse timing generator generates only a TOUT pulse given to a sensor chip that starts output first (a top chip). The top chip outputs the input TOUT pulse to the second sensor chip after the elapse of a fixed time. Similarly, each of the second and subsequent sensor chips outputs a TOUT pulse input from the pre-stage to a sensor chip at the post-stage after the elapse of the fixed time. In this way, in the second and subsequent sensor chips, a TOUT pulse to an nth sensor chip is input from a (n−1)th sensor chip (see, for example, Japanese Patent Application Laid-open No. H5-90559).

However, the ST pulse is supplied to the sensor chips in one line in parallel. Therefore, when the driving pulse timing generator is provided on the outside of the module (in the host apparatus), the sensor chips in one line are connected in parallel to one another to an ST pulse input terminal provided in the module. When the driving pulse timing generator is provided in the module, the sensor chips in one line are connected in parallel to one another to an ST pulse output terminal of the driving pulse timing generator. The wiring structure for the ST pulse causes hindrance in reducing wires and realizing a reduction in size of a module board.

### SUMMARY OF THE INVENTION

According to one aspect of the present invention, an image sensor includes a pulse input and output circuit that identifies a line synchronization pulse and an output start timing pulse sequentially input from an outside of a sensor chip, inputs the identified line synchronization pulse to an inside of the sensor chip and outputs the line synchronization pulse to an outside of the sensor chip, inputs the identified output start timing pulse to the inside of the sensor chip, and outputs an output start timing pulse, which is output from the inside of the sensor chip after elapse of a fixed time from the input, to the outside of the sensor chip following the line synchronization pulse output to the outside.

According to another aspect of the present invention, in an image sensor module in which a plurality of image sensors forming one line are arranged on a module board, each of the plurality of image sensors includes a pulse input and output circuit that identifies a line synchronization pulse and an output start timing pulse sequentially input from an outside of a sensor chip, inputs the identified line synchronization pulse to an inside of the sensor chip and outputs the line synchronization pulse to an outside of the sensor chip, inputs the identified output start timing pulse to the inside of the sensor chip, and outputs an output start timing pulse, which is output from the inside of the sensor chip after elapse of a fixed time from the input, to the outside of the sensor chip following the line synchronization pulse output to the outside, in an image sensor located at a top of the one line, the line synchronization pulse and the output start timing pulse are supplied in this order to an input end of the pulse input and output circuit from an outside of the module by using one transmission path, and in second and subsequent image sensors, an output end of the pulse input and output circuit of the image sensor at a pre-stage and an input end of the pulse input and output circuit of the image sensor at a post-stage are connected by one transmission path.

### BRIEF DESCRIPTION OF THE DRAWINGS

FIG. 1 is a block diagram illustrating the configuration of a contact image sensor and a contact image sensor module according to a first embodiment of the present invention;

FIG. 2 is a block diagram illustrating the configuration of a contact image sensor and a contact image sensor module according to a second embodiment of the present invention;

FIG. 3 is a diagram illustrating an example of amplitude values (during input) of an ST pulse and a TOUT pulse in a time series pulse used in a (first) configuration example of a pulse input and output circuit provided in each of sensor chips shown in FIGS. 1 and 2;

FIG. 4 is a diagram illustrating an example of amplitude values (during output) of the ST pulse and the TOUT pulse in the time series pulse used in the (first) configuration example of the pulse input and output circuit provided in each of the sensor chips shown in FIGS. 1 and 2;

FIG. 5 is a circuit diagram illustrating the (first) configuration example of the pulse input and output circuit provided in each of the sensor chips in which the amplitude values of the ST pulse and the TOUT pulse in the input and output time series pulse have relations shown in FIGS. 3 and 4;

FIG. 6 is a timing chart for explaining the operation of the pulse input and output circuit shown in FIG. 5;

FIG. 7 is a flowchart for explaining a (second) configuration example of the pulse input and output circuit provided in each of the sensor chips shown in FIGS. 1 and 2;

FIG. 8 is a timing chart for explaining the operation of the pulse input and output circuit configured according to the flowchart shown in FIG. 7;

FIG. 9 is a flowchart for explaining a (third) configuration example of the pulse input and output circuit provided in each of the sensor chips shown in FIGS. 1 and 2; and

FIG. 10 is a timing chart for explaining the operation of the pulse input and output circuit configured according to the flowchart shown in FIG. 8.

### DETAILED DESCRIPTION OF THE INVENTION

Exemplary embodiments of the present invention are explained in detail below with reference to the accompanying drawings. The present invention is not limited by the embodiments.

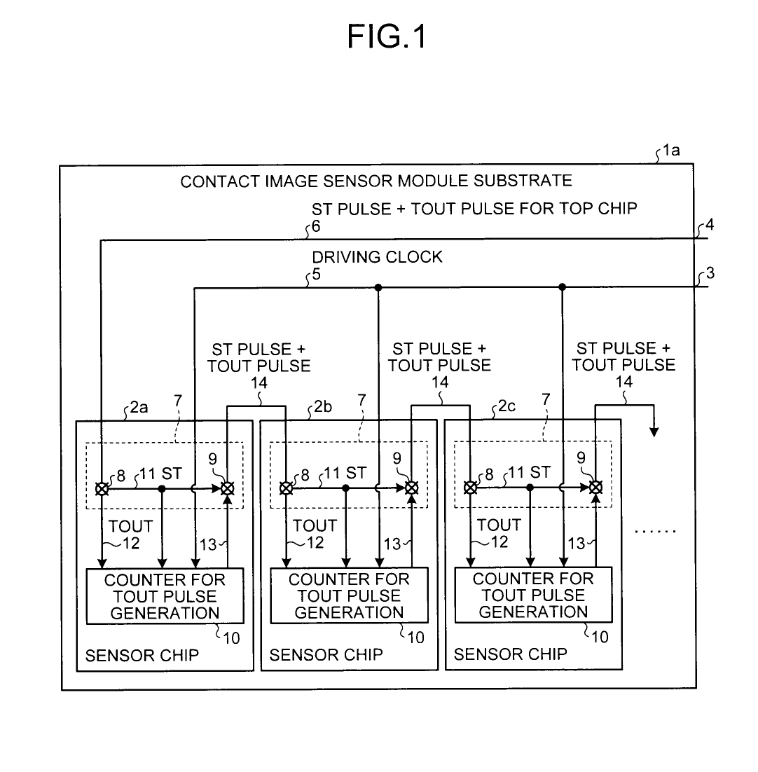

FIG. 1 is a block diagram illustrating the configuration of a contact image sensor and a contact image sensor module according to a first embodiment of the present invention. In the configuration of the contact image sensor and the contact image sensor module according to the first embodiment shown in FIG. 1, various driving pulses necessary for the operation of the contact image sensor module are supplied from a driving pulse timing generator (not shown) provided in a host apparatus on the outside of the module.

In FIG. 1, a plurality of contact image sensor chips (hereinafter simply referred to as “sensor chips”; three sensor chips 2a, 2b, and 2c are shown in FIG. 1) forming one line are mounted on a contact image sensor module board 1a such as a printed circuit board (PCB) and a printed wire board (PWB). In FIG. 1, among the sensor chips, the sensor chip 2a is assumed to be a top chip that starts operation first.

The not-shown driving pulse timing generator used in the first embodiment generates a driving clock (a master clock) in the same manner as the related art. However, the driving pulse timing generator generates an ST pulse common to the sensor chips (2a, 2b, and 2c) and a TOUT pulse for the top chip (2a) in time series as a series of pulse train in a relation explained later rather than separately generating and outputting the ST pulse and the TOUT pulse. Such a generation method is possible because the ST pulse is generated earlier than the TOUT pulse.

Therefore, as shown in FIG. 1, an input terminal 3 for the driving clock and an input terminal 4 common to the ST pulse and the TOUT pulse are provided on the contact image sensor module board 1a. Specifically, in the contact image sensor module board 1a, an ST pulse input terminal necessary in the past is not provided and a TOUT pulse input terminal used in the past is commonly used for the ST pulse. A driving clock 5 from the input terminal 3 is input to the sensor chips 2a, 2b, and 2c in parallel. A time series pulse “an ST pulse+a TOUT pulse for a top chip” 6 is input to the top sensor chip 2a.

Each of the sensor chips (2a, 2b, and 2c) according to this embodiment includes a pulse input and output circuit 7 that receives and processes the driving pulses. The pulse input and output circuit 7 includes a separating circuit 8 and a time series circuit 9 as basic components. A TOUT-pulse generation counter 10 is a component for counting a fixed time for generating the TOUT pulse for output to the post-stage explained in the related art. The counter for TOUT pulse generation 10 is extracted from the sensor chip and shown in the figure.

The separating circuit 8 of the top sensor chip 2a separates the time series pulse “an ST pulse+a TOUT pulse for a top chip” 6 from the input terminal 4 into an ST pulse 11 and a TOUT pulse 12. The separating circuit 8 of each of second to nth sensor chips separates a time series pulse “an ST pulse+a TOUT pulse” 14 from the time series circuit 9 of the (n−1)th sensor chip into the ST pulse 11 and the TOUT pulse 12. The separated TOUT pulse 12 is input to the counter for TOUT pulse generation 10. The separated ST pulse 11 is input to the counter for TOUT pulse generation 10 and the time series circuit 9.

The driving clock 5 from the input terminal 3 and the ST pulse 11 and the TOUT pulse 12 separated in the chip are input to the counter for TOUT pulse generation 10. The counter for TOUT pulse generation 10 is reset by the input of the ST pulse 11. The counter for TOUT pulse generation 10 starts the operation for counting the driving clock 5 in response to the TOUT pulse 12 input thereto after the ST pulse 11. When the counter for TOUT pulse generation 10 counts the number of pulses equivalent to the fixed time for generating the TOUT pulse for output to the post-stage, the counter for TOUT pulse generation 10 outputs a TOUT pulse 13 to the time series circuit 9.

The time series circuit 9 outputs the ST pulse 11 separated in the chip and the TOUT pulse 13 from the counter for TOUT pulse generation 10 to the separating circuit 8 of the sensor chip at the next stage as the time series pulse “an ST pulse+a TOUT pulse” 14 in which the ST pulse 11 and the TOUT pulse 13 are arranged in this order.

In each of the sensor chips in the contact image sensor module in the past, the ST pulse and the TOUT pulse are separately input from the outside of the chip. Therefore, an ST pulse input terminal is necessary in the sensor chip as an external input terminal.

On the other hand, in this embodiment, as shown in FIG. 1, the ST pulse is also transmitted by using a transmission path for the TOUT pulse. A time series pulse “an ST pulse+a TOUT pulse” is input to each of the sensor chips from the outside of the chip. Therefore, in each of the sensor chips, one external input terminal can be reduced because the ST pulse input terminal is unnecessary.

In this embodiment, the ST pulse does not have to be supplied to the sensor chips in parallel. Therefore, it is also possible to reduce wires on the contact image sensor module board 1a and reduce the size of the contact image sensor module board 1a.

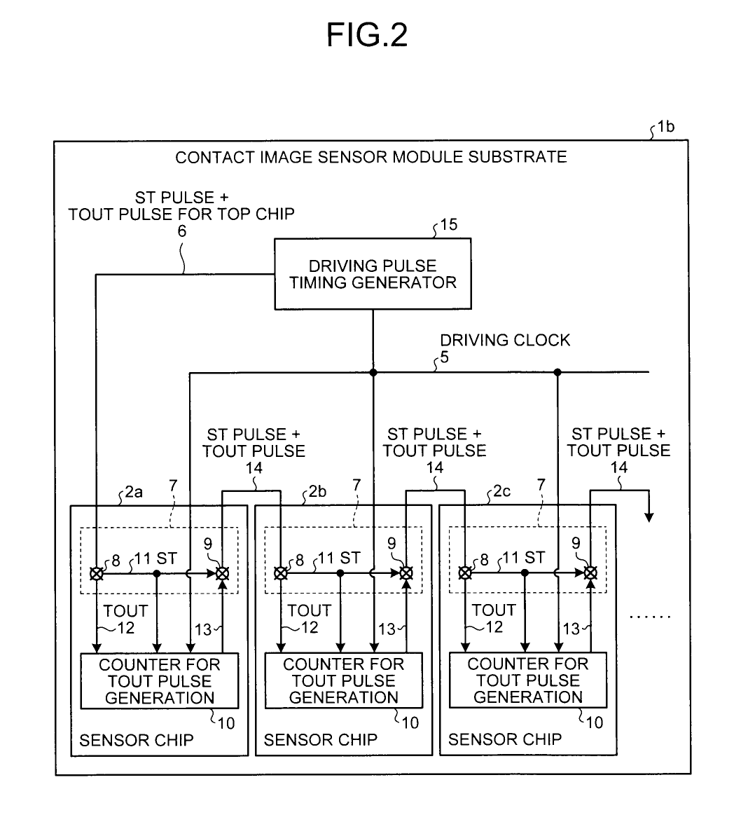

FIG. 2 is a block diagram illustrating a contact image sensor and a contact image sensor module according to a second embodiment of the present invention. In FIG. 2, components same as those shown in FIG. 1 (the first embodiment) are denoted by the same reference numerals and signs. Components related to the second embodiment are mainly explained below.

In the configuration of the contact image sensor and the contact image sensor module according to the second embodiment shown in FIG. 2, various driving pulses necessary for the operation of the contact image sensor module are supplied from a driving pulse timing generator provided in the module.

As shown in FIG. 2, a driving pulse timing generator 15 is mounted on a contact image sensor module board 1b such as a PCB and a PWB according to the second embodiment besides the sensor chips 2a, 2b, and 2c. The driving pulse timing generator 15 generates the driving clock 5 to the sensor chips (2a, 2b, and 2c) and the time series pulse “an ST pulse+a TOUT pulse for a top chip” 6 to the top sensor chip 2a.

With this configuration, as in the first embodiment, it is possible to reduce the number of external input terminals of each of the sensor chips by one. The ST pulse does not have to be supplied to the sensor chips in parallel. Therefore, it is also possible to reduce wires on the contact image sensor module board 1b and reduce the size of the contact image sensor module board 1b.

Configuration examples of the pulse input and output circuit 7 provided in each of the sensor chips are explained below.

### (1) (First) Configuration Example of the Pulse Input and Output Circuit 7

In a (first) configuration example, the driving pulse timing generator outputs an ST pulse and a TOUT pulse in a time series pulse with amplitude values of the pulses set different in a relation of (the amplitude of the ST pulse)>(the amplitude of the TOUT pulse). Each of the sensor chips identifies and separates an ST pulse and a TOUT pulse in an input time series pulse according to a difference between amplitude values thereof and outputs the ST pulse and the TOUT pulse to a sensor chip at the next stage as a time series pulse with the amplitude values thereof set different.

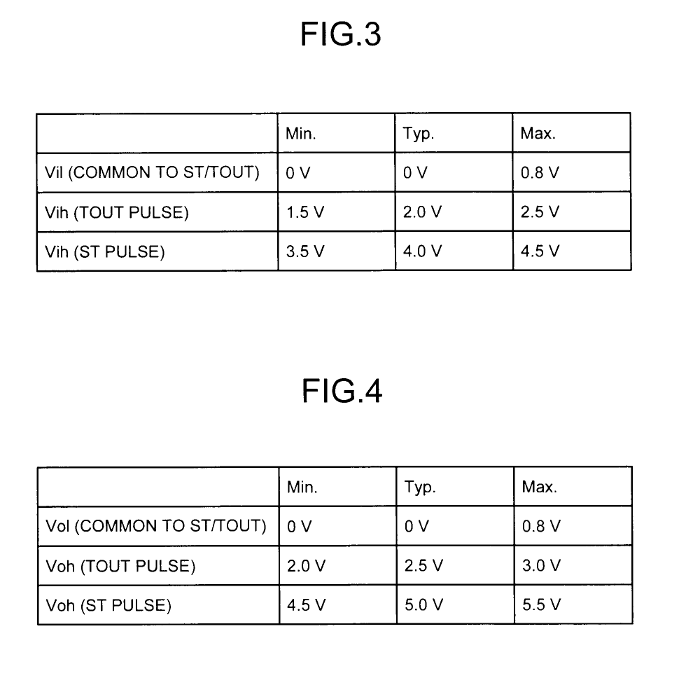

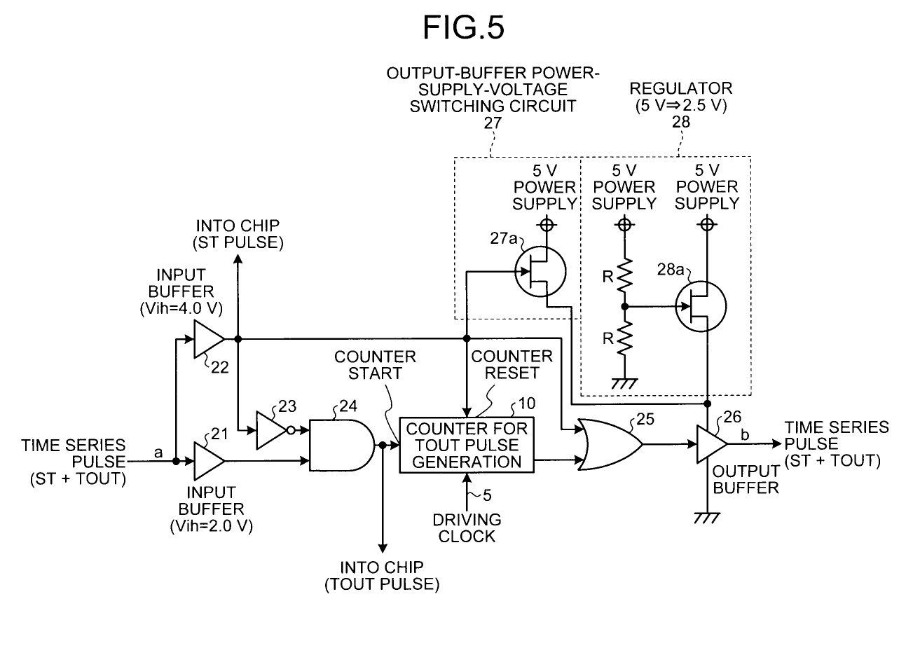

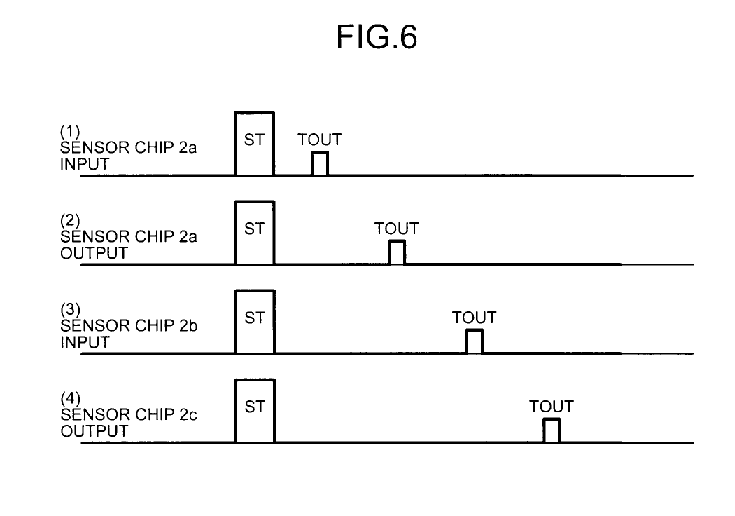

FIG. 3 is a diagram illustrating an example of amplitude values (during input) of an ST pulse and a TOUT pulse in a time series pulse used in the (first) configuration example of the pulse input and output circuit provided in each of the sensor chips shown in FIGS. 1 and 2. FIG. 4 is a diagram illustrating an example of amplitude values (during output) of the ST pulse and the TOUT pulse in the time series pulse used in the (first) configuration example of the pulse input and output circuit provided in each of the sensor chips shown in FIGS. 1 and 2. FIG. 5 is a circuit diagram illustrating the (first) configuration example of the pulse input and output circuit provided in each of the sensor chips in which the amplitude values of the ST pulse and the TOUT pulse in the input and output time series pulse have relations shown in FIGS. 3 and 4. FIG. 6 is a timing chart for explaining the operation of the pulse input and output circuit shown in FIG. 5.

As shown in FIGS. 3 and 4, each of the ST pulse and the TOUT pulse in the time series pulse input to and output from each of the sensor chips is a pulse having three values: a reference value (Typ.), a minimum value (Min.), and a maximum value (Max.). Voltage Vol at a Low level is Min.=0 V, Typ.=0 V, and Max.=0.8 V in common to the ST pulse and the TOUT pulse. On the other hand, voltage Vih at a High level is different in the ST pulse and the TOUT pulse and is higher in the ST pulse than in the TOUT pulse.

In FIG. 3, in the time series pulse during input, voltage Vih at the High level of the TOUT pulse is Min.=1.5 V, Typ.=2.0 V, and Max.=2.5 V. On the other hand, the voltage Vih at the High level of the ST pulse is Min.=3.5 V, Typ.=4.0 V, and Max.=4.5 V.

In FIG. 4, in the time series pulse during output, voltage Voh at the High level of the TOUT pulse is Min.=2.0 V, Typ.=2.5 V, and Max.=3.0 V. On the other hand, the voltage Voh at the High level of the ST pulse is Min.=4.5 V, Typ.=5.0 V, and Max.=5.5 V.

The voltages at the High level of the ST pulse and the TOUT pulse may be ideally equal. However, in actual application, voltage drop in a time series pulse path between chips needs to be taken into account. Therefore, in FIGS. 3 and 4, the voltage Voh at the High level during output is set to a value higher than the voltage Vih at the High level during input.

In FIG. 5, two input buffers 21 and 22, an inverter 23, and an AND gate 24 as a whole correspond to the separating circuit 8. An OR gate 25, an output buffer 26, an output-buffer power-supply-voltage switching circuit 27, and a regulator 28 as a whole corresponds to the time series circuit 8.

A time series pulse (ST+TOUT) a is input to the two input buffers 21 and 22 in parallel. In the example shown in the figure, a threshold value of the input buffer 22 is larger than a threshold value of the input buffer 21. Specifically, the input buffer 22 does not operate at the High level voltage Vih (Vih=2.0 V) of the TOUT pulse and sets an output to the Low level. However, when the High level voltage Vih (Vih=4.0 V) of the ST pulse is applied, the input buffer 22 sets the output to the High level. On the other hand, the input buffer 21 sets the output to the High level both when the High level voltage Vih (Vih=2.0 V) of the TOUT pulse is applied and when the High level voltage Vih (Vih=4.0 V) of the ST pulse is applied.

The output of the input buffer 21 is input to one input terminal of the AND gate 24. The output of the input buffer 22 is input to the other input terminal of the AND gate 24 via the inverter 23. The output of the AND gate 24 is input to a count start terminal of the counter for TOUT pulse generation 10.

The output of the input buffer 22 is input to a count reset terminal of the counter for TOUT pulse generation 10, one input terminal of the OR gate 25, and a gate terminal of a transistor 27a of the output-buffer power-supply-voltage switching circuit 27. The output of the counter for TOUT pulse generation 10 is input to the other input terminal of the OR gate 25. The output of the OR gate 25 is input to an input terminal of the output buffer 26. Power for the output buffer 26 is supplied from the output-buffer power-supply-voltage switching circuit 27 and the regulator 28.

In FIG. 5, High level voltages of the ST pulse and the TOUT pulse during input are set by assuming values at the reference values (Typ.) shown in FIGS. 3 and 4. Specifically, during input, the High level voltage Voh of the ST pulse is 4.0 volts and the High level voltage Voh of the TOUT pulse is 2.0 volts. During output, the High level voltage Voh of the ST pulse is 5.0 volts and the High level voltage Voh of the TOUT pulse is 2.5 volts.

The regulator 28 generates 2.5 volts from a 5 V power supply using a transistor 28a and a voltage dividing circuit including two resistors having resistance R and always applies generated 2.5 volts to a power supply terminal of the output buffer 26. On the other hand, in a period in which the transistor 27a is on, the output-buffer power-supply-voltage switching circuit 27 connects the 5 V power supply to the power supply terminal of the output buffer 26. Consequently, during a period in which the ST pulse is output, the output buffer 26 operates with the 5 V power supply. When the TOUT pulse is output, the output buffer 26 operates with the 2.5 V power supply.

A time series pulse 6 inputs to the top sensor chip 2a shown in FIGS. 1 and 2 is shown in (1) of FIG. 6. As a relation of order of input of the ST pulse and the TOUT pulse in the time series pulse 6, first, the ST pulse having a large amplitude value is input and the TOUT pulse having a small amplitude value is input at a certain interval. This order relation is the same in the ST pulse and the TOUT pulse in the time series pulse 14 input to the second and subsequent sensor chips.

Then, first, when the ST pulse having the High level voltage Vih=4.0 V is input, both the input buffers 21 and 22 set the outputs to the High level. When the input buffer 22 sets the output to the High level, the ST pulse is input to the chip. The ST pulse is input to the counter reset terminal of the counter for TOUT pulse generation 10. The counter for TOUT pulse generation 10 is reset in a period in which the ST pulse is at the High level. At this point, the input buffer 21 sets the output to the High level. However, because the inverter 23 sets the output to the Low level, the AND gate 24 sets the output to the Low level and the counter for TOUT pulse generation 10, to which the driving clock 5 is always input, is prohibited from performing the count operation.

At the same time, in a period in which the ST pulse is at the High level, the transistor 27a of the output-buffer power-supply-voltage switching circuit 27 is turned on, the 5 V power is supplied to the output buffer 26, and the ST pulse output from the OR gate 25 is output to the sensor chip at the next stage from the output buffer 26 as the ST pulse having Voh=5.0 V.

When the ST pulse disappears, both the input buffers 21 and 22 set the outputs to the Low level. Because the inverter 23 sets the output to the High level, the AND gate 24 maintains the output at the Low level and the counter for TOUT pulse generation 10 maintains the reset state. Because the transistor 27a of the output-buffer power-supply-voltage switching circuit 27 is turned off, 2.5 volts is supplied to the output buffer 26 from the regulator 28 instead of the 5 V power.

As shown in (1) of FIG. 6, when the TOUT pulse is input at a certain interval after the disappearance of the ST pulse, the input buffer 21 sets the output to the High level. Because the input buffer 22 maintains the output at the Low level, the AND gate 24 raises the output to the High level. Consequently, the TOUT pulse is input to the chip. The counter for TOUT pulse generation 10 starts the operation for counting the number of driving clocks 5 and, when the number of clocks equivalent to a fixed time is counted, outputs a TOUT pulse having predetermined pulse width. The TOUT pulse is input to the output buffer 26 via the OR gate 25. The TOUT pulse having Voh=2.5 V is output from the output buffer 26 in the sensor chip at the next stage. In this way, a time series pulse b output from the output buffer 26 is as shown in (2) of FIG. 6. The ST pulse is output at timing substantially the same as input timing. However, the TOUT pulse is output at timing delayed by a fixed time from input timing.

The time series pulse 14 output by the sensor chip 2a shown in (2) of FIG. 6 is input to the second sensor chip 2b. The time series pulse 14 shown in (3) of FIG. 6 is output from the sensor chip 2b. As shown in (3) of FIG. 6, as in the sensor chip 2a, in the time series pulse 14 output from the sensor chip 2b, the ST pulse is output at timing substantially the same as input timing. However, the TOUT pulse is output at timing delayed by a fixed time from input timing. Similarly, in the sensor chip 2c and subsequent sensor chips, synchronization control is performed at the same timing in the sensor chips and output start operation is performed at appropriate timing in each of the sensor chips.

### (2) (Second) Configuration Example of the Pulse Input and Output Circuit 7

In a (second) configuration example, the driving pulse timing generator outputs an ST pulse and a TOUT pulse in a time series pulse with High section lengths thereof set different in a relation of (the High section length of the ST pulse)>(the High section length of TOUT). Each of the sensor chips identifies and separates an ST pulse and a TOUT pulse in an input time series pulse and outputs the ST pulse and the TOUT pulse to the sensor chip at the next stage as a time series pulse with the High section lengths thereof set different in the same relation.

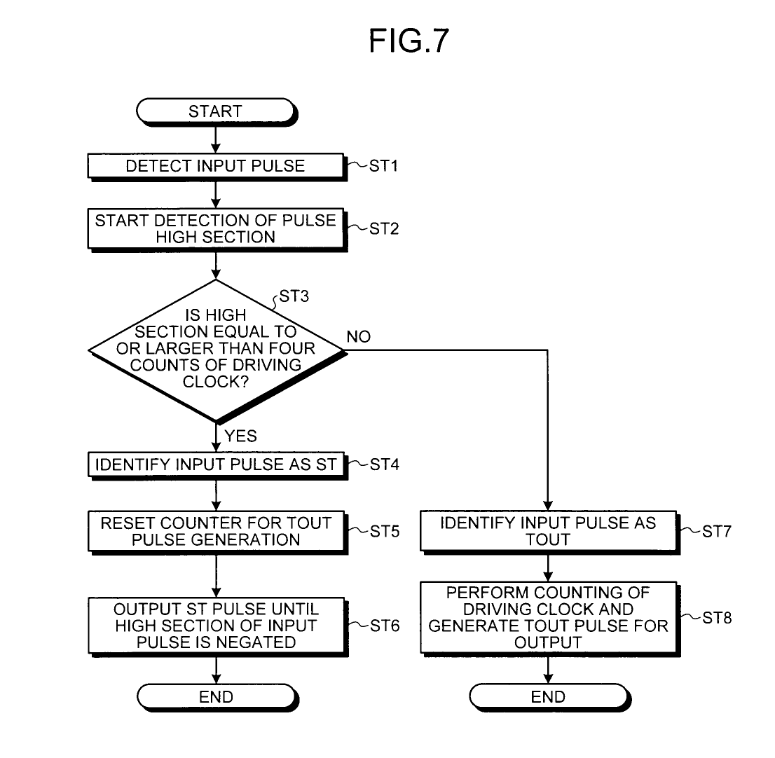

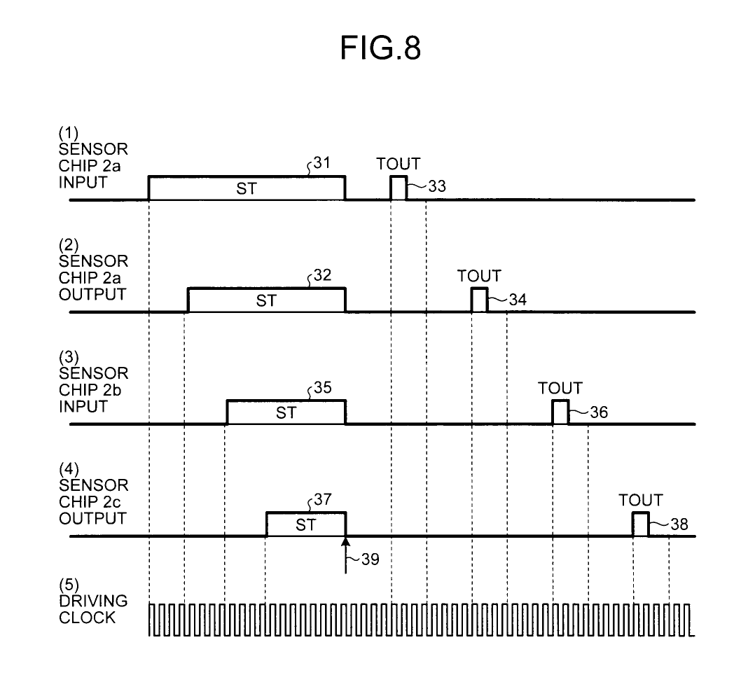

FIG. 7 is a flowchart for explaining the (second) configuration example of the pulse input and output circuit provided in each of the sensor chips shown in FIGS. 1 and 2. FIG. 8 is a timing chart for explaining the operation of the pulse input and output circuit configured according to the flowchart shown in FIG. 7.

In FIG. 7, when the pulse input and output circuit detects a pulse input (ST1), the pulse input and output circuit performs detection of High section length of the input pulse (ST2). The pulse input and output circuit checks whether a High section of the input pulse continues exceeding, for example, four counts of a driving clock (ST3).

As a result, when the High section of the input pulse continues exceeding the four counts of the driving clock (“Yes” at ST3), the pulse input and output circuit identifies the input pulse as an ST pulse (ST4) and resets the counter for TOUT pulse generation 10 (ST5). The pulse input and output circuit outputs the ST pulse in a period from a point when the High section of the input pulse exceeds the four counts of the driving clock to a point when the High section is negated (ST6) and ends the procedure.

When the High section of the input pulse does not exceed the four counts of the driving clock at ST3 (“No” at ST3), the pulse input and output circuit identifies the input pulse as a TOUT pulse (ST7). The pulse input and output circuit starts the counter for TOUT pulse generation 10 to perform counting of a driving clock. When the number of clocks equivalent to a fixed time is counted, the pulse input and output circuit generates and outputs a TOUT pulse to the next stage (ST8) and ends the procedure.

The time series pulse 6 input to the top sensor chip 2a shown in FIGS. 1 and 2 is shown in (1) of FIG. 8. In the top sensor chip 2a, an ST pulse 31 input first having a long High section is still at the High level at a point when four counts of a driving clock ((5) of FIG. 8) elapse from a rising point of the ST pulse 31. Therefore, the pulse input and output circuit raises an ST pulse 32 to be output to the High level. Consequently, the counter for TOUT pulse generation 10 is reset. The pulse input and output circuit continues the High section of the ST pulse 32 raised to the High level until a point when the ST pulse 31 falls. The pulse input and output circuit lowers the ST pulse 32 to the Low level at the falling point of the ST pulse 31. The ST pulse 32 having the High section length obtained by subtracting a section for four counts of the driving clock ((5) of FIG. 8) from the High section of the ST pulse 31 in this way is input to the sensor chip 2b at the next stage ((2) of FIG. 8).

In the top sensor chip 2a, a High section of a TOUT pulse 33 having a short High section input after the disappearance of the ST pulse 31 ends before the four counts of the driving clock ((5) of FIG. 8) elapse from a rising point of the TOUT pulse 33. Therefore, the pulse input and output circuit starts the counter for TOUT pulse generation 10 at a falling point of the TOUT pulse 33 to perform counting of the driving clock. When the umber of counts reaches the number of counts equivalent to a fixed time, the pulse input and output circuits generates a TOUT pulse 34 having short pulse width same as that of the TOUT pulse 33 and outputs the TOUT pulse 34 to the sensor chip 2b at the next stage ((2) of FIG. 8).

In the sensor chip 2b, operation same as the operation explained above is performed with the output of the sensor chip 2a ((2) of FIG. 8) set as an input. The pulse input and output circuit outputs an ST pulse 35 having High section length obtained by subtracting a section for four counts of the driving clock ((5) of FIG. 8) from the High section of the ST pulse 32 to the sensor chip 2c at the next stage. The pulse input and output circuit outputs a TOUT pulse 36 after the elapse of a fixed time from the TOUT pulse 34 ((3) of FIG. 8).

In the sensor chip 2c, operation same as the operation explained above is performed with the output of the sensor chip 2b ((3) of FIG. 8) set as an input. The pulse input and output circuit outputs an ST pulse 37 having High section length obtained by subtracting a section for four counts of the driving clock ((5) of FIG. 8) from the High section of the ST pulse 35 to the sensor chip at the next stage. The pulse input and output circuit outputs a TOUT pulse 38 after the elapse of a fixed time from the TOUT pulse 36 ((4) of FIG. 8).

In the (second) configuration example, an end point 39 of the High section of the ST pulse transmitted to the sensor chips is set to be the same in the sensor chips as shown in FIG. 8. Therefore, the pulse width of the ST pulse 31 input to the top sensor chip 2a is set such that an ST pulse having necessary High section length is obtained and a TOUT pulse having necessary High section length is obtained in a last sensor chip of one line.

### (3) (Third) Configuration Example of the Pulse Input and Output Circuit 7

In a (third) configuration example, the driving pulse timing generator outputs an ST pulse and a TOUT pulse in a time series pulse with the numbers of pulses thereof set different. Each of the sensor chips identifies and separates an ST pulse and a TOUT pulse in an input time series pulse according to the difference between the numbers of pulses and outputs the ST pulse and the TOUT pulse to a sensor chip at the next stage as a time series pulse with the numbers of pulses of the ST pulse and the TOUT pulse set different.

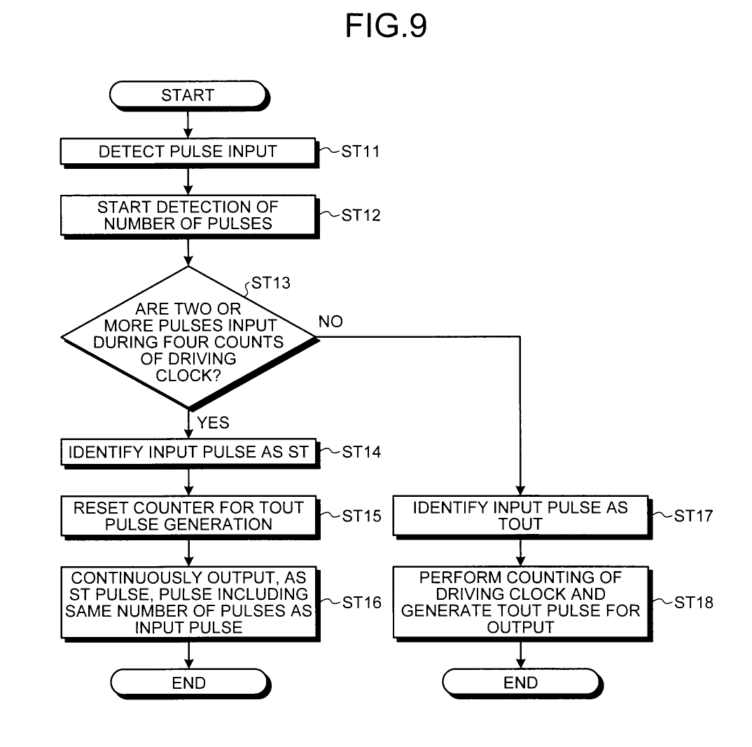

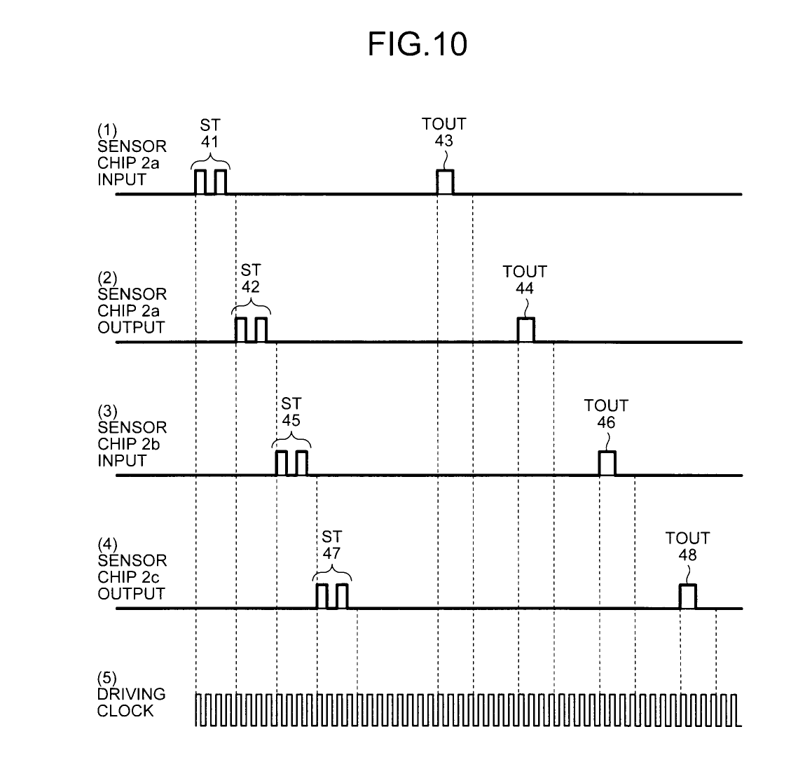

FIG. 9 is a flowchart for explaining the (third) configuration example of the pulse input and output circuit provided in each of the sensor chips shown in FIGS. 1 and 2. FIG. 10 is a time chart for explaining the operation of the pulse input and output circuit configured according to the flowchart shown in FIG. 9.

In FIG. 9, when the pulse input and output circuit detects a pulse input (ST11), the pulse input and output circuit detects the number of pulses of an input pulse (ST12) and checks whether two or more pulses are input during, for example, four counts of a driving clock (ST13).

As a result, when two or more pulses are input (“Yes” at ST13), the pulse input and output circuit identifies the input pulse as an ST pulse (ST14). The pulse input and output circuit resets the counter for TOUT pulse generation 10 (ST15), continuously outputs a pulse including the same number of pulses as the input pulse (ST16), and ends the procedure.

When one pulse is input in ST13 (“No” at ST13), the pulse input and output circuit identifies the input pulse as a TOUT pulse (ST17). The pulse input and output circuit starts the counter for TOUT pulse generation 10 to perform counting of a driving clock. When the number of clocks equivalent to a fixed time is counted, the pulse input and output circuit generates and outputs a TOUT pulse to the next stage (ST18) and ends the procedure.

In FIG. 10, operation performed when an ST pulse includes minimum two pulses is shown. In (1) of FIG. 10, the time series pulse 6 input to the top sensor chip 2a shown in FIGS. 1 and 2 is shown. In the top sensor chip 2a, an ST pulse 41 input first includes two pulses within four counts of a driving clock ((5) of FIG. 10) from a rising point thereof. Therefore, the pulse input and output circuit resets the counter for TOUT pulse generation 10 and outputs continuous two pulses as an ST pulse 42 to be output. In this way, the ST pulse 42 having the number of pulses same as the input ST pulse 41 is input to the sensor chip 2b at the next stage ((2) of FIG. 10).

In the top sensor chip 2a, a TOUT pulse 43 input after the disappearance of the ST pulse 41 includes one pulse within four counts of the driving clock ((5) of FIG. 8) from a rising point of the TOUT pulse 43. Therefore, the pulse input and output circuit starts the counter for TOUT pulse generation 10 at a falling point of the TOUT pulse 43 to perform counting of a driving clock. When the number of counts reaches the number of counts equivalent to a fixed time, the pulse input and output circuit generates a TOUT pulse 44 having pulse width same as that of the TOUT pulse 43 and outputs the TOUT pulse 44 to the sensor chip 2b at the next stage ((2) of FIG. 10).

In the sensor chip 2b, operation same as the operation explained above is performed with the output of the sensor chip 2a ((2) of FIG. 10) set as an input. The pulse input and output circuit outputs continuous two pulses to the sensor chip 2c at the next stage as an ST pulse 45 during four counts of the driving clock ((5) of FIG. 10) for detecting the ST pulse 42. The pulse input and output circuit outputs a TOUT pulse 46 after the elapse of a fixed time from the TOUT pulse 44 ((3) of FIG. 10).

In the sensor chip 2c, operation same as the operation explained above is performed with the output of the sensor chip 2b ((3) of FIG. 10) set as an input. The pulse input and output circuit outputs continuous two pulses to the sensor chip at the next stage as an ST pulse 47 during four counts of the driving clock ((5) of FIG. 10) for detecting the ST pulse 45. The pulse input and output circuit outputs a TOUT pulse 48 after the elapse of a fixed time from the TOUT pulse 46 ((4) of FIG. 10).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image sensor comprising:
a pulse input and output circuit that identifies a line synchronization pulse and an output start timing pulse sequentially input from an outside of a sensor chip, inputs the identified line synchronization pulse to an inside of the sensor chip and outputs the line synchronization pulse to an outside of the sensor chip, inputs the identified output start timing pulse to the inside of the sensor chip, and outputs an output start timing pulse, which is output from the inside of the sensor chip after elapse of a fixed time from the input, to the outside of the sensor chip following the line synchronization pulse output to the outside.

2. The image sensor according to claim 1, wherein the pulse input and output circuit identifies, based on a difference between amplitude values of the line synchronization pulse and the output start timing pulse sequentially input from the outside of the sensor chip, the line synchronization pulse and the output start timing pulse, and sequentially outputs a line synchronization pulse and an output start timing pulse having a same relation of a difference between amplitude values to the outside of the sensor chip.

3. The image sensor according to claim 1, wherein the pulse input and output circuit identifies, based on a difference between High section lengths of the line synchronization pulse and the output start timing pulse sequentially input from the outside of the sensor chip, the line synchronization pulse and the output start timing pulse, and sequentially outputs a line synchronization pulse and an output start timing pulse having a same relation of a difference between High section lengths to the outside of the sensor chip.

4. The image sensor according to claim 1, wherein the pulse input and output circuit identifies, based on whether High section lengths of the line synchronization pulse and the output start timing pulse sequentially input from the outside of the sensor chip are equal to or larger than a predetermined count value of a driving clock, the line synchronization pulse and the output start timing pulse, and sequentially outputs a line synchronization pulse and an output start timing pulse having a same relation of a difference between High section lengths to the outside of the sensor chip.

5. The image sensor according to claim 1, wherein the pulse input and output circuit identifies, based on a difference between numbers of pulses of the line synchronization pulse and the output start timing pulse sequentially input from the outside of the sensor chip, the line synchronization pulse and the output start timing pulse, and sequentially outputs a line synchronization pulse and an output start timing pulse having a same relation of a difference between numbers of pulses to the outside of the sensor chip.

6. The image sensor according to claim 1, wherein the pulse input and output circuit identifies, based on whether the line synchronization pulse and the output start timing pulse sequentially input from the outside of the sensor chip are input by a number of pulses equal to or larger than a certain number of pulses in a predetermined count value of a driving clock, the line synchronization pulse and the output start timing pulse, and sequentially outputs a line synchronization pulse and an output start timing pulse having a same relation of a difference between numbers of pulses to the outside of the sensor chip.

7. The image sensor according to claim 1, wherein the pulse input and output circuit includes:
two input buffers connected in parallel to each other to one input line to which the line synchronization pulse and the output start timing pulse are sequentially input from the outside of the sensor chip in an amplitude value relation that amplitude of the line synchronization pulse is larger than amplitude of the output start timing pulse, the two input buffers including a first input buffer having a threshold value lower than the amplitude value of the output start timing pulse and a second input buffer having a threshold value higher than the amplitude value of the output start timing pulse and lower than the amplitude value of the line synchronization pulse;
a power supply circuit that outputs a first voltage only in a period in which the second input buffer outputs the line synchronization pulse and thereafter outputs a second voltage lower than the first voltage;
an AND gate that inputs, to the chip, the output start timing pulse obtained by calculating an AND of an output of the first input buffer and a signal obtained by logically inverting an output of the second input buffer;
an OR gate receives, as one input, the line synchronization pulse output by the second input buffer and receives, as the other input, an output start timing pulse generated by a counter in the chip in response to input of the output start timing pulse from the AND gate, the counter being reset by the line synchronization pulse input to the chip and output by the second input buffer; and
an output buffer that receives, as operation power supplies, the first voltage applied in the period in which the second input buffer outputs the line synchronization pulse and the second voltage applied after the end of the application of the first voltage, and outputs the line synchronization pulse and the output start timing pulse sequentially input from the OR circuit respectively with amplitude values of voltages corresponding thereto of the operation power supplies.

8. An image sensor module in which a plurality of image sensors forming one line are arranged on a module board, wherein
each of the plurality of image sensors includes a pulse input and output circuit that identifies a line synchronization pulse and an output start timing pulse sequentially input from an outside of a sensor chip, inputs the identified line synchronization pulse to an inside of the sensor chip and outputs the line synchronization pulse to an outside of the sensor chip, inputs the identified output start timing pulse to the inside of the sensor chip, and outputs an output start timing pulse, which is output from the inside of the sensor chip after elapse of a fixed time from the input, to the outside of the sensor chip following the line synchronization pulse output to the outside,
in an image sensor located at a top of the one line, the line synchronization pulse and the output start timing pulse are supplied in this order to an input end of the pulse input and output circuit from an outside of the module by using one transmission path, and
in second and subsequent image sensors, an output end of the pulse input and output circuit of the image sensor at a pre-stage and an input end of the pulse input and output circuit of the image sensor at a post-stage are connected by one transmission path.

9. The image sensor module according to claim 8, wherein the pulse input and output circuit included in each of the image sensors identifies, based on a difference between amplitude values of the line synchronization pulse and the output start timing pulse sequentially input from the outside of the sensor chip, the line synchronization pulse and the output start timing pulse, and sequentially outputs a line synchronization pulse and an output start timing pulse having a same relation of a difference between amplitude values to the outside of the sensor chip.

10. The image sensor module according to claim 8, wherein the pulse input and output circuit included in each of the image sensors identifies, based on a difference between High section lengths of the line synchronization pulse and the output start timing pulse sequentially input from the outside of the sensor chip, the line synchronization pulse and the output start timing pulse, and sequentially outputs a line synchronization pulse and an output start timing pulse having a same relation of a difference between High section lengths to the outside of the sensor chip.

11. The image sensor module according to claim 8, wherein the pulse input and output circuit identifies, based on whether High section lengths of the line synchronization pulse and the output start timing pulse sequentially input from the outside of the sensor chip are equal to or larger than a predetermined count value of a driving clock, the line synchronization pulse and the output start timing pulse, and sequentially outputs a line synchronization pulse and an output start timing pulse having a same relation of a difference between High section lengths to the outside of the sensor chip.

12. The image sensor module according to claim 8, wherein the pulse input and output circuit included in each of the image sensors identifies, based on a difference between numbers of pulses of the line synchronization pulse and the output start timing pulse sequentially input from the outside of the sensor chip, the line synchronization pulse and the output start timing pulse, and sequentially outputs a line synchronization pulse and an output start timing pulse having a same relation of a difference between numbers of pulses to the outside of the sensor chip.

13. The image sensor module according to claim 8, wherein the pulse input and output circuit identifies, based on whether the line synchronization pulse and the output start timing pulse sequentially input from the outside of the sensor chip are input by a number of pulses equal to or larger than a certain number of pulses in a predetermined count value of a driving clock, the line synchronization pulse and the output start timing pulse, and sequentially outputs a line synchronization pulse and an output start timing pulse having a same relation of a difference between numbers of pulses to the outside of the sensor chip.

14. An image sensor module in which a plurality of image sensors forming one line are arranged on a module board, wherein
each of the plurality of image sensors includes a pulse input and output circuit that identifies a line synchronization pulse and an output start timing pulse sequentially input from an outside of a sensor chip, inputs the identified line synchronization pulse to an inside of the sensor chip and outputs the line synchronization pulse to an outside of the sensor chip, inputs the identified output start timing pulse to the inside of the sensor chip, and outputs an output start timing pulse, which is output from the inside of the sensor chip after elapse of a fixed time from the input, to the outside of the sensor chip following the line synchronization pulse output to the outside,
in an image sensor located at a top of the one line, the line synchronization pulse and the output start timing pulse are supplied in this order to an input end of the pulse input and output circuit from a driving pulse timing generator arranged on an inside of the module by using one transmission path, and
in second and subsequent image sensors, an output end of the pulse input and output circuit of the image sensor at a pre-stage and an input end of the pulse input and output circuit of the image sensor at a post-stage are connected by one transmission path.

15. The image sensor module according to claim 14, wherein the pulse input and output circuit included in each of the image sensors identifies, based on a difference between amplitude values of the line synchronization pulse and the output start timing pulse sequentially input from the outside of the sensor chip, the line synchronization pulse and the output start timing pulse, and sequentially outputs a line synchronization pulse and an output start timing pulse having a same relation of a difference between amplitude values to the outside of the sensor chip.

16. The image sensor module according to claim 14, wherein the pulse input and output circuit included in each of the image sensors identifies, based on a difference between High section lengths of the line synchronization pulse and the output start timing pulse sequentially input from the outside of the sensor chip, the line synchronization pulse and the output start timing pulse, and sequentially outputs a line synchronization pulse and an output start timing pulse having a same relation of a difference between High section lengths to the outside of the sensor chip.

17. The image sensor module according to claim 14, wherein the pulse input and output circuit identifies, based on whether High section lengths of the line synchronization pulse and the output start timing pulse sequentially input from the outside of the sensor chip are equal to or larger than a predetermined count value of a driving clock, the line synchronization pulse and the output start timing pulse, and sequentially outputs a line synchronization pulse and an output start timing pulse having a same relation of a difference between High section lengths to the outside of the sensor chip.

18. The image sensor module according to claim 14, wherein the pulse input and output circuit included in each of the image sensors identifies, based on a difference between numbers of pulses of the line synchronization pulse and the output start timing pulse sequentially input from the outside of the sensor chip, the line synchronization pulse and the output start timing pulse, and sequentially outputs a line synchronization pulse and an output start timing pulse having a same relation of a difference between numbers of pulses to the outside of the sensor chip.

19. The image sensor module according to claim 14, wherein the pulse input and output circuit identifies, based on whether the line synchronization pulse and the output start timing pulse sequentially input from the outside of the sensor chip are input by a number of pulses equal to or larger than a certain number of pulses in a predetermined count value of a driving clock, the line synchronization pulse and the output start timing pulse, and sequentially outputs a line synchronization pulse and an output start timing pulse having a same relation of a difference between numbers of pulses to the outside of the sensor chip.
